(19) United States
(12) Patent Application Publication
(10) Pub. No.: US 2009/0085840 A1
(43) Pub. Date: Apr. 2, 2009

(54) PLASMA DISPLAY AND DRIVING METHOD THEREOF

(76) Inventors: Soo-Kwan Jang, Suwon-si (KR); Kwang-Jong Suh, Suwon-si (KR)

Correspondence Address: CHRISTIE, PARKER & HALE, LLP, PO BOX 7068, PASADENA, CA, 91109-7068, US

(21) Appl. No.: 12/210,934

(22) Filed: Sep. 15, 2008

(30) Foreign Application Priority Data
Sep. 27, 2007 (KR) 10-2007-0097308

(51) Int. Cl. G09G 3/28

(52) U.S. Cl. 345/67

(57) ABSTRACT

A method for driving a plasma display including scan electrodes, address electrodes, sustain electrodes, and a plurality of discharge cells with one frame divided into a plurality of subfields. In the method, a voltage of the scan electrode is gradually increased from a second voltage to a third voltage while applying a first voltage to the address electrode during a first reset period of a first subfield among the plurality of subfields, and the voltage of the scan electrode is gradually increased from a fifth voltage to a sixth voltage that is lower than the third voltage while applying a fourth voltage that is higher than the first voltage to the address electrode during a second reset period of a second subfield among the plurality of subfields.

### CROSS-REFERENCE TO RELATED APPLICATION

This application claims priority to and the benefit of Korean Patent Application No. 10-2007-0097308, filed in the Korean Intellectual Property Office on Sep. 27, 2007, the entire content of which is incorporated herein by reference.

### BACKGROUND OF THE INVENTION

1. Field of the Invention

The present invention relates to a plasma display and a driving method thereof.

2. Description of the Related Art

A plasma display is a display device that uses a plasma display panel (PDP) for displaying characters or images using plasma that is generated by a gas discharge. In the PDP, a plurality of cells are disposed in a matrix format. The plasma display displays a frame of an image by dividing it into a plurality of subfields for driving.

An image frame displayed by the plasma display is divided into a plurality of subfields each having a weight value for driving. In an address period of each subfield, cells to be turned on are selected by sequentially applying a scan pulse to a plurality of scan electrodes, and in a sustain period, sustain discharges are performed in the turn-on cells (e.g., light emitting cells) in order to actually display an image by alternately applying a high level voltage and a low level voltage of the sustain discharge pulses to electrodes for performing sustain discharges. Here, reset periods of some subfields of one frame include a main reset period for generating a reset discharge in all cells, and reset periods of the remaining subfields include an auxiliary reset period for generating a reset discharge in light emitting cells in which the sustain discharge has been generated in a previous subfield.

When the sustain discharge is generated in a previous subfield, many wall charges and space charges are formed in the cell. In some plasma displays, since a protective layer having a high secondary electron emission characteristic is formed on an address electrode, many space charges may be formed in the cell. Accordingly, after an addressing operation is performed in the cell in the address period, the wall charges of the address electrode may be lessened by the amount of the space charges. Thereby, the address discharge and the sustain discharge may not be appropriately generated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a plasma display with improved discharge stability and reduced delay of a sustain discharge in a sustain period to appropriately perform the sustain discharge, and a driving method thereof.

According to an exemplary embodiment of the present invention, in a method for driving a plasma display that includes scan electrodes, address electrodes, sustain electrodes, and a plurality of discharge cells with one frame divided into a plurality of subfields, a voltage of a scan electrode of the scan electrodes is gradually increased from a second voltage to a third voltage while a first voltage is applied to the address electrodes during a first reset period of a first subfield among the plurality of subfields, and the voltage of the scan electrode is gradually increased from a fifth voltage to a sixth voltage that is lower than the third voltage while a fourth voltage that is higher than the first voltage is applied to the address electrodes during a second reset period of a second subfield among the plurality of subfields.

According to another exemplary embodiment of the present invention, in a driving method of a plasma display that includes first electrodes, second electrodes, third electrodes crossing the first electrodes and the second electrodes, and a plurality of discharge cells formed by the first, second, and third electrodes with one frame divided into a plurality of subfields, a voltage difference which is obtained by subtracting a voltage of a third electrode of the third electrodes from a voltage of a corresponding one of the first electrodes is gradually increased from a first voltage to a second voltage, the voltage difference is gradually decreased from a third voltage to a fourth voltage during a reset period of a first subfield among the plurality of subfields, the voltage difference is gradually increased from a fifth voltage to a sixth voltage that is lower than the second voltage, and the voltage difference is gradually decreased from a seventh voltage to an eighth voltage during a reset period of a second subfield among the plurality of subfields.

In addition, according to yet another exemplary embodiment of the present invention, a plasma display includes a first electrode, a second electrode, a third electrode that crosses the first and second electrodes, a controller for dividing one frame into a plurality of subfields, and a driver. The driver is configured to gradually increase a voltage difference which is obtained by subtracting a voltage of the second electrode from a voltage of the first electrode from a first voltage to a second voltage during a rising period of a reset period of a first subfield among the plurality of subfields, gradually decrease the voltage difference from a third voltage to a fourth voltage during a falling period of the reset period of the first subfield, gradually increase the voltage difference from a fifth voltage to a sixth voltage during a rising period of a reset period of a second subfield among the plurality of subfields, and gradually decrease the voltage difference from a seventh voltage to an eighth voltage during a falling period of the reset period of the second subfield. Further, the driver applies a ninth voltage to the third electrode during the rising period of the reset period of the first subfield, and applies a tenth voltage that is higher than the ninth voltage to the third electrode during the rising period of the reset period of the second subfield.

### BRIEF DESCRIPTION OF THE DRAWINGS

FIG. 1 is a block diagram of a plasma display according to an exemplary embodiment of the present invention.

FIG. 2 is a diagram representing a driving method of the plasma display according to the exemplary embodiment of the present invention.

FIG. 3 is a diagram representing driving waveforms of a plasma display according to a first exemplary embodiment of the present invention.

FIG. 4 is a diagram representing driving waveforms of a plasma display according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise”, and variations such as “comprises” and “comprising,” will be understood to imply the inclusion of stated elements but not the exclusion of any other elements. Furthermore, while wall charges are referred to as being formed on the electrodes, those skilled in the art would appreciate that the wall charges are formed on walls (e.g., dielectric layer) covering the electrodes.

A plasma display according to an exemplary embodiment of the present invention and a driving method thereof will now be described with reference to the figures.

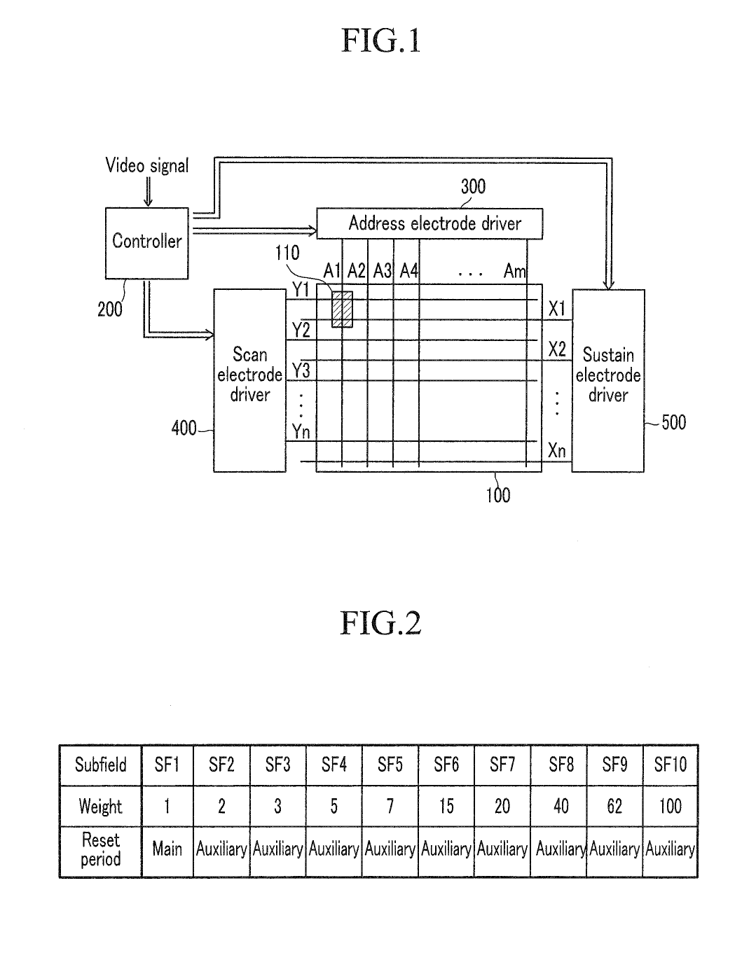

FIG. 1 is a block diagram of a plasma display according to an exemplary embodiment of the present invention.

As shown in FIG. 1, the plasma display according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and pluralities of sustain and scan electrodes X1 to Xn and Y1 to Yn extending in a row direction in pairs. The sustain electrodes X1 to Xn are formed corresponding to the scan electrodes Y1 to Yn, respectively. Discharge spaces at crossing regions of the address electrodes A1 to Am and the sustain and scan electrodes X1 to Xn and Y1 to Yn form discharge cells 110 (hereinafter referred to as “cells”). It is to be noted that the above construction of the PDP 100 is only an example, and PDPs having different structures, to which a driving waveform to be described later can be applied, may be applied to the present invention.

The controller 200 receives an external video signal and outputs an address electrode driving control signal, a sustain electrode driving control signal, and a scan electrode driving control signal. The controller 200 divides one frame into a plurality of subfields respectively having weights according to the input video signal, and the each of the subfields includes an address period and a sustain period. The address period is for selecting turn-on/turn-off cells (i.e., cells to be turned on/off), and the sustain period is for performing a display operation by sustain-discharging the turn-on cells. In addition, at least one of the plurality of subfields may further include a reset period. The reset period is for initializing at least one of the plurality of cells.

The address electrode driver 300 applies a driving voltage to the plurality of address electrodes A1 to Am according to the address electrode driving control signal from the controller 200.

The scan electrode driver 400 applies a driving voltage to the plurality of scan electrodes Y1 to Yn according to the scan electrode driving control signal from the controller 200.

The sustain electrode driver 500 applies a driving voltage to the plurality of sustain electrodes X1 to Xn according to the sustain electrode driving control signal from the controller 200.

FIG. 2 is a diagram representing a driving method of the plasma display according to the exemplary embodiment of the present invention.

As shown in FIG. 2, one frame includes a plurality of subfields each having a different weight value. In FIG. 2, one frame includes 10 subfields SF1 to SF10 respectively having weight values of 1, 2, 3, 5, 7, 15, 20, 40, 62, and 100, thereby displaying gray levels from 0 to 255. The subfields SF1 to SF10 each include a reset period, an address period, and a sustain period. Here, reset periods of some subfields among the plurality of subfields are main reset periods for initializing all cells, and reset periods of remaining subfields are auxiliary reset periods for initializing cells in which a sustain discharge has been generated in a previous subfield. In FIG. 2, a reset period of the first subfield SF1 is the main reset period, and reset periods of the remaining subfields SF2 to SF10 are the auxiliary reset periods.

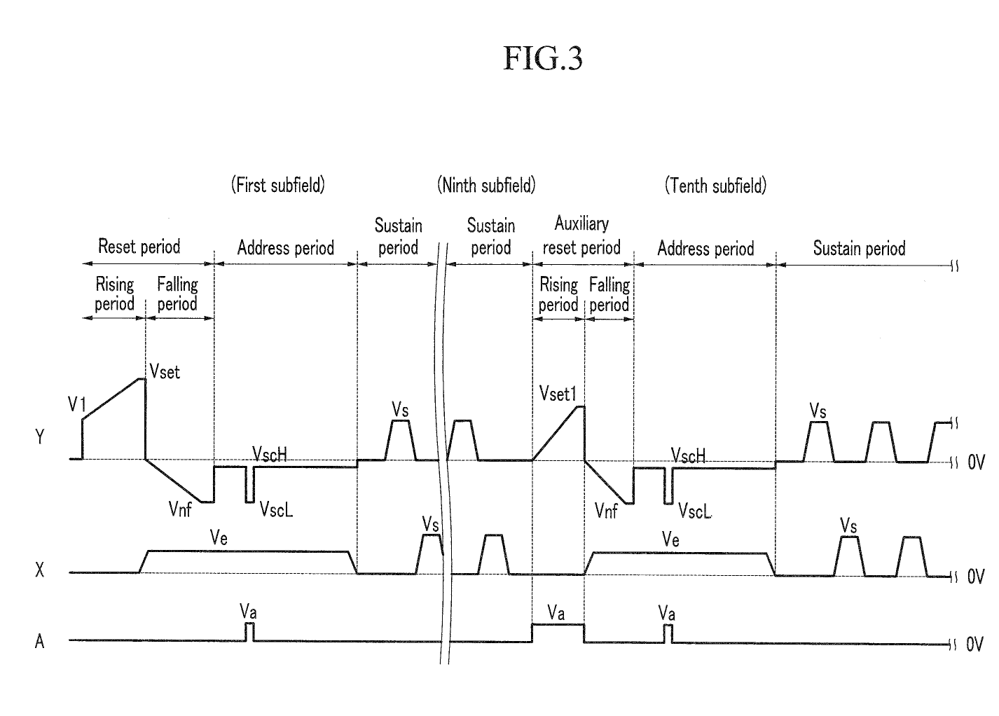

FIG. 3 is a diagram representing driving waveforms of a plasma display according to a first exemplary embodiment of the present invention. In FIG. 3, for better understanding and ease of description, only driving waveforms of the first subfield SF1 and the tenth subfield SF10 among the plurality of subfields are illustrated, and it will be described based on a cell corresponding to one scan electrode Y, one sustain electrode X, and one address electrode A.

As shown in FIG. 3, in a rising period of the main reset period of the first subfield SF1, the sustain electrode X and the address electrode A are maintained at a reference voltage (0V in FIG. 3), and a voltage at the scan electrode Y is gradually increased from a V1 voltage to a Vset voltage. In FIG. 3, the voltage of the scan electrode Y is increased in a ramp pattern. While the voltage of the scan electrode Y increases, a weak discharge is generated between the scan electrode Y and the sustain electrode X and between the scan electrode Y and the address electrode A, and therefore negative wall charges (−) are formed on the scan electrode Y, and positive wall charges (+) are formed on the sustain electrode X and the address electrode A. Here, a voltage of (VscH-VscL) corresponding to a difference between a VscH voltage and a VscL voltage that are used in the address period, and a Vs voltage used in the sustain period may be used as the V1 voltage.

In a falling period of the main reset period, while the address electrode A and the sustain electrode X are respectively maintained at the reference voltage and a Ve voltage, the voltage at the scan electrode Y is gradually decreased from the reference voltage (0V in FIG. 3) to a Vnf voltage. Thereby, a weak discharge is generated between the scan electrode Y and the sustain electrode X and between the scan electrode Y and the address electrode A while the voltage of the scan electrode Y is decreased, and therefore the negative wall charges (−) formed on the scan electrode Y and the positive wall charges formed on the sustain electrode X and the address electrode A are eliminated. In general, a voltage of (Vnf-Ve) is set to be close to a discharge firing voltage between the scan electrode Y and the sustain electrode X. Therefore, since a wall voltage between the scan electrode Y and the sustain electrode X is nearly 0V, a cell in which the address discharge is not generated in the address period may be prevented from being misfired in the sustain period.

In FIG. 3, while it is illustrated that the voltage of the scan electrode Y decreases in the falling period from the reference voltage, another voltage (e.g., the Vs voltage) may be used.

In the address period, to select a turn-on cell, while the Ve voltage is applied to the sustain electrode X, a scan pulse having a VscL voltage and an address pulse having a Va voltage are applied to the scan electrode Y and the address electrode A, respectively. Here, the scan electrode Y to which the scan pulse is not applied is maintained at a VscH voltage that is higher than the VscL voltage. The VscL voltage may be the same as or lower than the Vnf voltage. In addition, the 0V voltage that is lower than the Va voltage is applied to the address electrode of a non-light emitting cell among the cells corresponding to the scan electrode Y to which the scan pulse is applied. Therefore, the address discharge is generated in the cell corresponding to the address electrode A to which the Va voltage is applied and the scan electrode Y to which the VscL voltage is applied.

In further detail, in the address period, the scan electrode driver 400 and the address electrode driver 300 apply the scan pulse to the scan electrode Y (Y1 in FIG. 1) of a first row, and at the same time, apply the address pulse to the address electrode A corresponding to a light emitting cell of the first row. Here, the VscH voltage is applied to the scan electrodes (Y2 to Yn in FIG. 1) of the remaining rows. Therefore, since the address discharge is generated between the scan electrode Y (Y1 in FIG. 1) of the first row and the address electrode A to which the address pulse is applied, the positive wall charges (+) are formed on the scan electrode Y (Y1 in FIG. 1) and the negative wall charges (−) are formed on the address electrode A and the sustain electrode X (X1 in FIG. 1). Subsequently, while applying the scan pulse to the scan electrode Y (Y2 in FIG. 2) of a second row, the address electrode driver 300 applies the address pulse to the address electrode A corresponding to the light emitting cell of the second row. In a like manner, the VscH voltage is applied to the scan electrodes (Y1 and Y3 to Yn in FIG. 1) of the remaining rows. Therefore, the address discharge is generated in the cell formed by the address electrode A to which the address pulse is applied and the scan electrode Y (Y2 in FIG. 1) of the second row, and the wall charges are formed in the cell. In a like manner, while sequentially applying the scan pulse to the scan electrodes Y of the remaining rows, the address electrode driver 300 applies the address pulse to the address electrode A corresponding to the light emitting cell to form the wall charges.

In the sustain period, a sustain pulse having a high level voltage (Vs voltage in FIG. 3) and a low level voltage (0V voltage in FIG. 3) is alternately applied to the scan electrode Y and the sustain electrode X. Here, a phase of the sustain pulse applied to the scan electrode Y is opposite to that of the sustain electrode X. That is, the 0V voltage is applied to the sustain electrode X when the Vs voltage is applied to the scan electrode Y, and the Vs voltage is applied to the sustain electrode X when the 0V voltage is applied to the scan electrode Y. Thus, a difference between the voltages of the scan electrode Y and the sustain electrode X alternately becomes the Vs voltage and a −Vs voltage, and therefore, the sustain discharge is generated a number of times (e.g., a predetermined number of times) in a turn-on discharge cell. Here, various voltages may be used as the high level voltage and the low level voltage as long as a voltage difference between the high level voltage and the low level voltage alternates between the Vs voltage and the −Vs voltage. For example, a Vs/2 voltage as the high level voltage and a −Vs/2 voltage as the low level voltage may be used. In addition, while the 0V voltage is applied to one of the scan electrode Y or the sustain electrode X, the Vs voltage and the −Vs voltage may be alternately applied to the other of the scan electrode or the sustain electrode.

Subsequently, in a rising period of the auxiliary reset period of the subfield SF10, since a sustain discharge is generated when the Vs voltage is applied to the sustain electrode X in a sustain period of a previous subfield F9, the sustain electrode X is maintained at the reference voltage (0V voltage in FIG. 3), and the voltage of the scan electrode Y is gradually increased from the reference voltage (0V voltage in FIG. 3) to a Vset1 voltage. Here, the voltage at the scan electrode Y gradually increases with a slope gentler than a slope at which the voltage at the scan electrode Y or the sustain electrode X is increased from the 0V voltage to the Vs voltage in the sustain period. Therefore, since the positive wall charges (+) are formed on the scan electrode Y and the address electrode A, and the negative wall charges (−) are formed on the sustain electrode X corresponding to the cell in which the sustain discharge is generated in the previous subfield SF9, a weak discharge is generated between the scan electrode Y and the sustain electrode X and between the scan electrode Y and the address electrode A while the voltage of the scan electrode Y increases. Accordingly, the negative wall charges (−) are formed on the scan electrode Y, and the positive wall charges (+) are formed on the sustain electrode X. Here, when a positive voltage (Va voltage in FIG. 3) is applied to the address electrode A during the rising period of the auxiliary reset period, a large amount of positive wall charges (+) may be prevented from being generated on the address electrode A since a voltage difference between the scan electrode Y and the address electrode A becomes less than the voltage difference when the 0V voltage is applied to the address electrode A.

In addition, the Vset1 voltage may be set to be lower than a discharge firing voltage (i.e., a Ve-Vnf voltage) between the scan electrode Y and the sustain electrode X so that the cell in which the sustain discharge is not generated in the previous subfield may not be discharged in the rising period of the auxiliary reset period. Here, the Vset1 voltage may be set to be the same as the Vs voltage, and a power source for supplying the Vs voltage may also supply the Vset1 voltage to reduce the number of power sources used in the plasma display.

In a falling period of the auxiliary reset period, in a like manner of the falling period of the main reset period, the voltage of the scan electrode Y is gradually decreased to the Vnf voltage. Here, since less of the positive wall charges (+) have been formed on the address electrode A, no significant discharge is generated between the address electrode A and the scan electrode Y, and less space charges are formed in the cell.

Subsequently, in a like manner as the subfield SF1, operations of the address and sustain periods are performed in the subfield SF10. Here, since less space charges are formed in the cell, loss of the wall charges formed on the address electrode A by the space charges after the address period may be prevented or reduced.

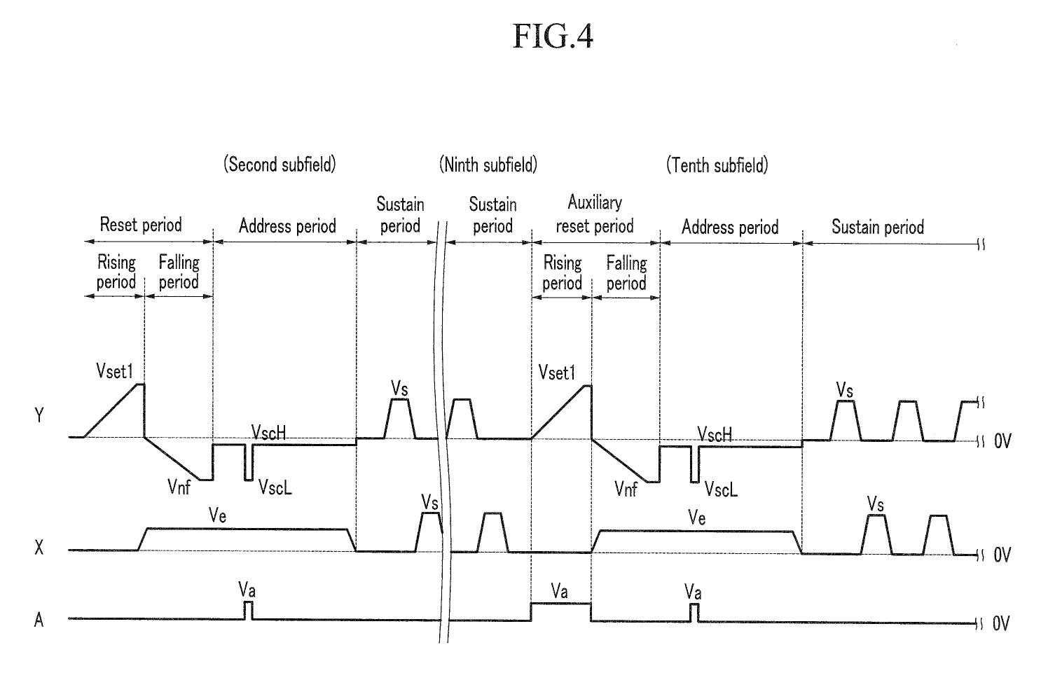

In addition, since less space charges by the sustain discharge have been formed in the cell of the subfield in which the sustain discharge is slightly generated in the previous subfield, loss of the wall charges formed on the address electrode A may be prevented or reduced when a large amount of space charges are formed in the auxiliary reset period. In general, since the subfields of one frame are arranged in an order of increasing weight values, the sustain discharge generated in a previous subfield is less than that generated in subsequent subfield. Accordingly, in the subfield having a lower weight value, a positive voltage may not be applied to the address electrode during the rising period of the auxiliary reset period, which will be described with reference to FIG. 4.

FIG. 4 is a diagram representing driving waveforms of a plasma display according to a second exemplary embodiment of the present invention. In FIG. 4, for better understanding and ease of description, only driving waveforms of the second subfield SF2 and the tenth subfield SF10 among the plurality of subfields are illustrated, and it will be described based on a cell corresponding to one sustain electrode X, one scan electrode Y, and one address electrode A.

Here, the plurality of subfields SF1 to SF10 are grouped as a first group having the main reset period (e.g., the subfield SF1), a second group having the auxiliary reset period and a lower weight value (e.g., the subfields SF1 to SF5), and a third group having the auxiliary reset period and a higher weight value (e.g., the subfields SF6 to SF10). As shown in FIG. 4, the reference voltage (0V in FIG. 4) may be applied to the address electrode A during the rising period of the auxiliary reset period in the subfields SF1 to SF5 of the second group, and the positive voltage (Va in FIG. 4) may be applied to the address electrode A during the rising period of the auxiliary reset period in the subfields SF6 to SF10 of the third group. In FIG. 4, for better understanding and ease of description, only one subfield (SF2) among the subfields of the second group and one subfield (SF10) among the subfields of the third group are illustrated.

In addition, since significant space charges are generated in the cell when a protective layer having a high secondary electron emission characteristic is used to cover the address electrode A, the driving method according to the first and second exemplary embodiments of the present invention may be applied to such plasma display including the protective layer having the secondary electron emission characteristic. For example, a magnesium oxide (MgO) protective layer doped with at least one among Sc, Al, Ca, and Zr may be used as the protective layer.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

1. A method of driving a plasma display with one frame divided into a plurality of subfields, the plasma display comprising scan electrodes, address electrodes, sustain electrodes, and a plurality of discharge cells, the method comprising:
gradually increasing a voltage of a scan electrode of the scan electrodes from a second voltage to a third voltage while applying a first voltage to the address electrodes during a first reset period of a first subfield among the plurality of subfields; and
gradually increasing the voltage of the scan electrode from a fifth voltage to a sixth voltage that is lower than the third voltage while applying a fourth voltage that is higher than the first voltage to the address electrodes during a second reset period of a second subfield among the plurality of subfields.

2. The method of claim 1, wherein the plurality of subfields are grouped into a plurality of groups comprising a first group, a second group, and a third group, the first group comprises the first subfield, the third group comprises the second subfield, and a weight value of a subfield of the third group is higher than a weight value of a subfield of the second group.

3. The method of claim 2, further comprising gradually increasing the voltage of the scan electrode from the fifth voltage to the sixth voltage while applying the first voltage to the address electrode during a third reset period of a third subfield of the second group.

4. The method of claim 1, further comprising:
gradually decreasing the voltage of the scan electrode from a seventh voltage to an eighth voltage while applying the first voltage to the address electrode during the first reset period; and
gradually decreasing the voltage of the scan electrode from a ninth voltage to a tenth voltage while applying the first voltage to the address electrode during the second reset period.

5. The method of claim 4, wherein the eighth voltage is the same as the tenth voltage.

6. The method of claim 1, wherein while gradually increasing the voltage of the scan electrode from the second voltage to the third voltage in the first reset period, the first voltage is applied to the sustain electrode, and
while gradually increasing the voltage of the scan electrode from the fifth voltage to the sixth voltage in the second reset period, the first voltage is applied to the sustain electrode.

7. The method of claim 6, wherein while gradually decreasing the voltage of the scan electrode from the ninth voltage to the tenth voltage, an eleventh voltage is applied to the sustain electrode during the second reset period, and
wherein a difference between the sixth voltage and the first voltage is less than or equal to a difference between the eleventh voltage and the tenth voltage.

8. The method of claim 1, further comprising, in the first and second subfields:
selecting a light emitting cell and a non-light emitting cell during an address period; and
sustain-discharging the light emitting cell during a sustain period.

9. A method of driving a plasma display with a frame divided into a plurality of subfields, the plasma display comprising first electrodes, second electrodes, third electrodes crossing the first electrodes and the second electrodes, and a plurality of discharge cells formed by the first, second, and third electrodes, the method comprising:
gradually increasing a voltage difference which is obtained by subtracting a voltage of a third electrode of the third electrodes from a voltage of a corresponding one of the first electrodes from a first voltage to a second voltage, and gradually decreasing the voltage difference from a third voltage to a fourth voltage during a reset period of a first subfield among the plurality of subfields;
gradually increasing the voltage difference from a fifth voltage to a sixth voltage that is lower than the second voltage; and
gradually decreasing the voltage difference from a seventh voltage to an eighth voltage during a reset period of a second subfield among the plurality of subfields.

10. The method of claim 9, wherein a reset discharge is not substantially generated in a cell among the plurality of cells which is not emitted in a previous subfield among the plurality of subfields during the reset periods of the first and second subfields.

11. The method of claim 9, further comprising gradually increasing a second voltage difference which is obtained by subtracting a voltage of a second electrode of the second electrodes from the voltage of the first electrode from a ninth voltage to a tenth voltage; and
gradually decreasing the second voltage difference from an eleventh voltage to a twelfth voltage during the respective reset periods of the first and second subfields, wherein a magnitude of the tenth voltage is less than or equal to a magnitude of the twelfth voltage.

12. The method of claim 9, wherein the third and fourth voltages are respectively the same as the seventh and eighth voltages.

13. The method of claim 9, wherein a weight value of the second subfield is higher than a weight value of the first subfield.

14. A plasma display comprising:
a first electrode;
a second electrode;
a third electrode crossing the first electrode and the second electrode;
a controller for dividing one frame into a plurality of subfields; and
a driver for gradually increasing a voltage difference which is obtained by subtracting a voltage of the second electrode from a voltage of the first electrode from a first voltage to a second voltage during a rising period of a reset period of a first subfield among the plurality of subfields, gradually decreasing the voltage difference from a third voltage to a fourth voltage during a falling period of the reset period of the first subfield, gradually increasing the voltage difference from a fifth voltage to a sixth voltage during a rising period of a reset period of a second subfield among the plurality of subfields, and gradually decreasing the voltage difference from a seventh voltage to an eighth voltage during a falling period of the reset period of the second subfield,
wherein the driver applies a ninth voltage to the third electrode during the rising period of the reset period of the first subfield, and applies a tenth voltage that is higher than the ninth voltage to the third electrode during the rising period of the reset period of the second subfield.

15. The plasma display of claim 14, further comprising a protective layer on the second electrode, the protective layer comprising magnesium oxide (MgO), wherein the protective layer further comprises at least one of Sc, Al, Ca, or Zr.

16. The plasma display of claim 14, wherein a magnitude of the sixth voltage is greater than a magnitude of the eighth voltage.

17. The plasma display of claim 14, wherein the second voltage is higher than the sixth voltage.

18. The plasma display of claim 14, wherein a weight value of the second subfield is higher than a weight value of the first subfield.
